(19) United States
(12) Patent Application Publication
(10) Pub. No.: US 2018/0133096 A1
(43) Pub. Date: May 17, 2018

(54) Curved Flexible Massage Roller

(71) Applicant: Rick Loos, Del Mar, CA (US)

(72) Inventor: Rick Loos, Del Mar, CA (US)

(21) Appl. No.: 15/118,435

(22) PCT Filed: Aug. 5, 2016
(86) PCT No.: PCT/US2016/045883

§ 371 Date: Aug. 11, 2016

Related U.S. Application Data
(63) Continuation of application No. 29/556,039, filed on Feb. 26, 2016, now Pat. No. D800330.
(60) Provisional application No. 62/201,511, filed on Aug. 5, 2015.

(51) Int. Cl. A61H 15/00

(52) U.S. Cl. CPC A61H 15/00; A61H 2015/0014; A61H 2203/0437; A61H 2203/0406; A61H 2203/0431; A61H 2201/1623

(57) ABSTRACT

A curved massage roller is provided allowing for rolling against the body of a user in treatment of body, back-related, muscular or skeletal ailments. The roller is adapted for positioning between the user and a support surface whereupon it is rolled during use. Dual arched segments with a central relief help maintain the roller in place during use and avoid nerve damage when employed on the back of the body.

This application claims priority to U.S. Provisional Patent Application Ser. No. 62/201511 filed on Aug. 5, 2015, and to U.S. Design Patent Application Number 29/556039, filed on Feb. 26, 2016, both of which are included herein in their respective entirety, by this reference thereto.

### FIELD OF THE INVENTION

The device herein disclosed relates generally to the art of back massage and soft tissue treatment tools. More particularly, the disclosed device relates to a roller configured to massage and treat back related muscular or skeletal ailments, with a dual curved massaging surface and which includes a recessed surface to accommodate and protect the spine and nerves adjacent thereto, during operative employment of the device.

### BACKGROUND OF THE INVENTION

Massaging of muscles, tendons, and ligaments has been employed for thousands of years and is known to provide therapeutic benefits to patients. Such is provided subsequent to such massage therapy which results in the loosening of tight muscles to increase flexibility and overcome injuries to soft tissues such as adhesions, knots, and scar tissues.

Traditionally, trained massagers employ a specific measurement of pressure application the kneading and pulling of differing tissues during massage therapy for treating muscle injuries and other body tissue ailments.

Manually employable mechanical massagers, which allow a user to self-treat through a configuration of the massaging device to yield mechanical advantage, have been widely developed. Such devices have been provided to help users maintain good back health without the need or ability to employ a massage provider. Some such devices employ a planar cylindrical roller which allows the user to apply rolling massage pressure upon areas of their body such as their back through vertical or horizontal translation of a handle engaged with the roller. Other such roller related massaging components have been known to use a roller adapted for positioning between a user and a support surface such as a wall or floor. In this mode the roller is sandwiched between the body of the user and against a fixed vertical or horizontal surface respectively. Movement by the user results in a rolling of the roller across the user's body.

Although some of these products are effective at providing compressive force against the back muscles and tendons, such rollers are conventionally smooth about their exterior surface. Further, while some employ a rotating roller, the surface of the roller is generally planar from one end to the opposite.

Consequently, these planar roller contact the body of the user, which is usually not planar, in unequal amounts and varying positions. Further, unless the roller is sufficiently pliable to prevent impact and abrasion against the user's spine and nerves extending therefrom, accidental harmful contact with the spine and these surrounding nerves can risk injury to those sensitive areas. Of course, should the roller be planar yet pliable enough to avoid such hard contact with the spine and surrounding areas, frequently it will be too soft for therapeutic use.

As such, there exists an unmet need, for a back self-massaging tool which allows the user to employ it to relieve muscle and tendon ailments for increased back health. Such a device should be easily employed by the user, but should not be configured where a resulting massage will risk misalignment of the spine or damage to adjacent nerves. Such a device in addition to having a shape to accommodate the spine and surrounding tissue during use, should also have an arched surface which provides improved massage to the user and the ability of the roller to contact contoured areas of the body a planar roller misses.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### OBJECTS OF THE INVENTION

It is an object of the present invention to provide a massage device providing mechanical advantage during use to allow the user to massage their own back and body to maintain back health.

It is another object of this invention that the massage device can be easily employed by the user with one side against their body and the other against a horizontal or vertical fixed surface, or could be handle-mounted.

It is a further object of this invention that the roller device have a relief or recess in a central area of the roller to form a gap during use to protect against accidental pressure against the spine or surrounding sensitive nerves and concurrently hold the roller centered during use.

These and other objects, features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### SUMMARY OF THE INVENTION

In accordance with the purposes of the present invention, as embodied and broadly described herein, the present invention provides a device configured as a back pain treatment tool.

The device is comprised of a roller body formed by an elongated member formed of polymeric material or plastic suitable to the task. The elongated member has an exterior surface which is symmetrically bisected into a first segment forming a first arched segment and a second segment forming a second arched segment, such that the exterior surface and outer diameter of the formed roller, increases and then decreases from the distal to the proximal edge of each segment. So configured, the symmetric first and second arched segments of the elongated member create two curved peak massage surfaces which significantly increase contact of the roller surface with the contours of a user's back and body surfaces.

Centered between the two arched surfaces is a recessed area positioned in between each of the two arched surfaces. This recessed area forms a central groove which during use will tend to self-center the roller on the back of the user with the recess positioned over the spine and areas adjacent the spine. With this configuration of a recess positioned in between opposing arched roller surfaces, little or no contact pressure is communicated to the spine or tissue and surrounding nerves or nerve pathways extending from the spine during use. This is most important to prevent damage to the nerves and spine and connective tissues.

Further as noted, it has been found during experimentation, that by forming the exterior surface of the roller with substantially identical arched roller surfaces on opposing sides of the recess, that the roller will stay centered during rolling. Such was not the case when the roller was formed with two opposing planar rolling surfaces with a recess in-between. This coupled with the better contact with the curved and contoured body of users afforded by the dual arched roller has rendered this mode of the device favored over other planar modes which were tried.

The formed dual arched roller with recessed central portion may be formed as a solid structure. However, it has been found that forming an axial recess in the roller renders it lighter and for some users, easier to employ with less force being required against the roller moving upon a wall or flat surface. The lighter weight of the roller with an axial cavity would therefor be preferable to save manufacturing material, and to lighten the weight of the roller for ease of use. Of course a light weight polymeric material could also be used in a solid form of the roller.

In a current mode of the device, it has been found that, where the axial pathway or cavity is formed in the roller, insertion of a non malleable member therein prevents deflection of the roller and will maintain the roller straight during use. This prevents bending of the roller where the arched surfaces during use might be curved off their respective axis.

Therefore, a cylindrical member is engaged within the axial cavity in the preferred mode. The device, thus, is preferred with a cylindrical member positioned within the axial cavity. Retainment of the cylindrical member is provided by one or a combination of frictional engagement, adhesive engagement, or compressive engagement. In a compressive engagement, the circumference of the cylindrical member will be slightly larger than the circumference of the axial cavity. Upon insertion from one side of the roller, the polymeric material forming the roller will stretch over the roller exterior, and impart a compressive engagement thereto.

In another especially preferred mode of the device, a ledge of polymeric material forming the roller overhangs the aperture at each end of the roller which communicates with the axial cavity. In this mode the circular member has a length which is equal to or less than the length of the axial cavity, in-between the annular ledge portions overhanging both apertures at both ends. This ledge portion is sufficiently flexible and elastic to allow insertion of the circular member such that when inserted through the opening centrally located within each annular ledge, the circular member will be positioned within the axial cavity with ledge portions abutting both ends of the circular member and preventing removal.

The rigidity of the inserted cylindrical member should be greater than the stiffness of the polymeric material and outer member, and can alternatively be capped at each end for increased distal strength. This cylindrical member can also be sized to engage the device upon a handled roller to allow the user, or another individual, to roll the roller defined by a first member across their body for massage when the device is not employed using a wall or floor surface.

Engagement between the cylindrical member and roller or outer members can mate through one or a combination of permanent or temporary engagement including adhesive, hook and loop fasteners, zippers, slip fits, clasps, buttons or snaps. Alternatively, the cylindrical inner member and the roller or outer members can permanently mate through one or a combination of shrink-fit, force fits, glue, epoxy, heat shrink or overmolding.

To accommodate the shape and geography of the human back, and provide excellent massage, experimentation has shown that the device may work best with a diameter to the peak or widest point of each arch, of between 2 and 12 inches. Experimentation has also shown a roller length of 8 to 24 inches from end to end works well for use with most users thereby making each arched section of the roller from 4 to 12 inches in length from the end of the roller to where they meet at a central area.

Additionally, the ratio of the minimum to the maximum diameter at the peak of each arch on the roller or outer member should be between 5 and 80 percent to ensure sufficient lateral grip against the user's back during use. Further, the distance between the peak diameters on the outer member have shown to work well between 30 and 90 percent of the length of the roller from end to end.

Finally, it is most preferable that the exterior surface of each arched segment of the roller formed by the outer member should contain 3 or more rows of 3 or more radially arrayed projections extending away from a smooth surface. These projections have, in experimentation, been shown to provide for increased grip against the user and the stationary surface to maintain the device in operative position during use. Further, each projections acts as a massaging pressure point or fingers during a massage of the user's back during treatment.

Additionally, the projections allow the device to roll rather than slide on a smooth surface such as a wall or floor and thereby operate better since sliding stops the massage action of the device.

Each projection should preferably be spherical in shape so as not to cut or injure th user. Alternatively they may be formed as a square or round cylinder, should a more rigors contact with the user and surface be desired. In all cases they should be sized for sufficient grip and massaging capability.

The first or outer member of the device can be composed of one or a combination of durable flexible materials from a group including polymeric materials, foam, plastic, rubber, silicone, neoprene, polyethylene and polyurethane.

The cylindrical inner member can be formed from one or a combination of durable rigid or semi-rigid materials from a group including metal, plastic, wood, PVC, polycarbonate, polyurethane, polypropylene.

The protrusions or projections on the exterior of both arched roller surfaces, can be formed homogeneously with the material forming the roller or outer member or from any of the alternative flexible materials listed above.

Employing the device herein, in one preferred mode, the user lies down, places the device between his or her back and a horizontal stationary surface, and employs one or both legs to translate their body, and the device, in a horizontal direction to repeatedly treat the affected area of the back.

Alternatively, the user can similarly place the device between the surface of their back and a vertical stationary surface, such as a chair or wall respectively. So positioned the user will repeatedly translate their body in a vertical direction to cause the device to roll and massage the affected area of the back.

With respect to the above description, before explaining at least one preferred embodiment of the herein disclosed invention in detail, it is to be understood that the invention is not limited in its application to the details of construction and to the arrangement of the components in the following description or illustrated in the drawings. The device herein described and disclosed in the various modes and combinations is also capable of other embodiments and of being practiced and carried out in various ways which will be obvious to those skilled in the art. Any such alternative configuration as would occur to those skilled in the art is considered within the scope of this patent. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other back treatment devices for carrying out the several purposes of the present disclosed device. It is important, therefore, that the claims be regarded as including such equivalent construction and methodology insofar as they do not depart from the spirit and scope of the present invention.

### BRIEF DESCRIPTION OF DRAWING FIGURES

The accompanying drawings, which are incorporated herein and form a part of the specification, illustrate some, but not the only nor exclusive examples of embodiments and/or features of the disclosed device. It is intended that the embodiments and figures disclosed herein are to be considered illustrative of the invention herein, rather than limiting in any fashion.

In the drawings:

FIG. 1 depicts an isometric view of the roller device showing the exterior surface having curved arches and a formed recess in a central portion of the roller in-between the arched exterior surfaces.

FIG. 2 displays a side view of the device of FIG. 1 showing the two arched segments of the roller and the recesses central area in-between.

FIG. 3 shows an end view of the device of FIG. 1 and FIG. 2, and in dotted line depicts the cylindrical member inserted within the axial cavity and the annular ledge extending beyond the inner circumference of the member.

FIG. 4 depicts a user employing the device in an as-used position sandwiched between the user and a support surface, per one preferred mode.

FIG. 5 shows a user employing the device in an as-used position, per another preferred mode in a vertical direction.

FIG. 6 displays a user employing the device in an as-used position in another preferred mode while standing and bending at the knees to vertically translate their body and roll the roller sandwiched between the wall surface and their back.

### DETAILED DESCRIPTION OF THE INVENTION

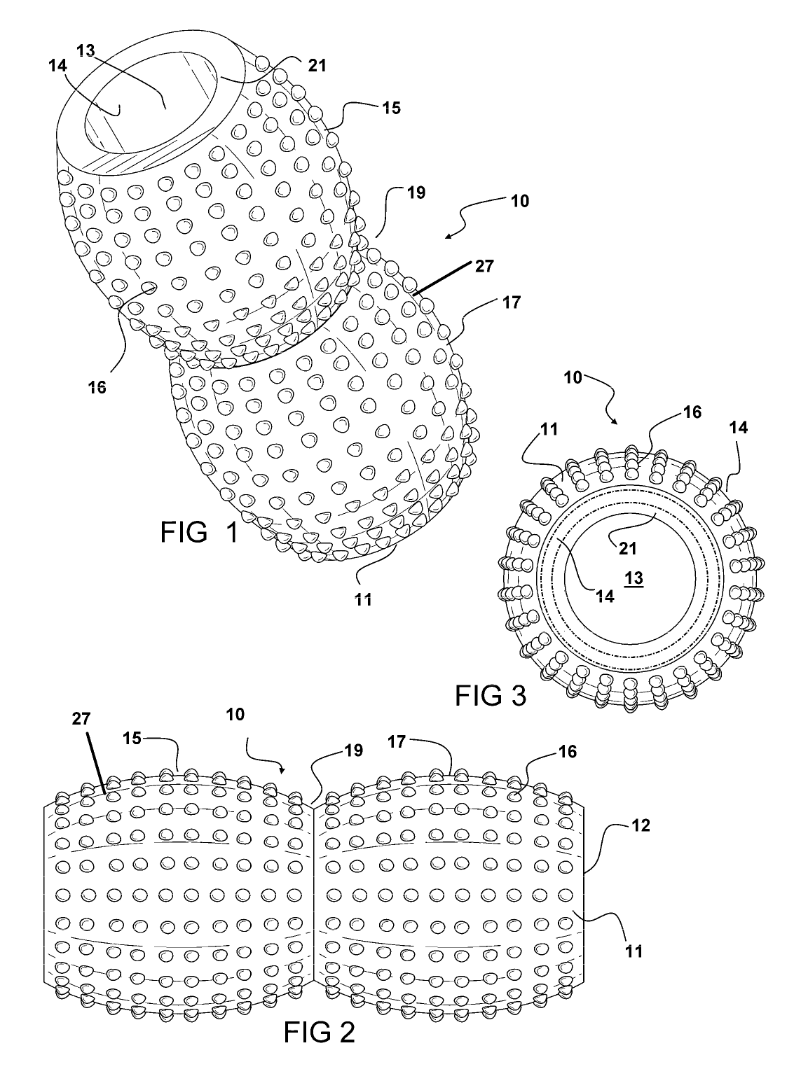

Now referring to drawings in FIGS. 1-6, wherein similar components are identified by like reference numerals, there is seen the device 10 configured as a back pain treatment tool. Per FIGS. 1-3, the device 10 is comprised of a roller 11 defined by an first member 12, and if having an axial cavity 13 running therethrough as in FIGS. 1 and 3, can also include an inner member 14, running axially within the axial cavity 13 formed in the first member 12. However, as noted, the roller 11 may be formed by a first member 12 having a solid core and still provide the benefits of the adjacent first arched segment 15 and second arched segment 17 formed on the exterior circumference of the roller 11 with the recess 19 positioned therebetween.

The first member 12 defining the roller 11, has an exterior surface 27 extending between a first and a second end, and is preferably symmetrically bisected upon this exterior circumference, to a formed first arched segment 15 and a second arced segment 16, which is best seen when viewed from a side such as in FIG. 2. In each of the first arched segment 15 and second segment 17 formed on the exterior circumference of the roller 11 defined by the first member 12, the diameter and exterior circumference of the device 10, increases to a peak at the central area of each segment 15 and 17, and then decreases from the distal to the proximal edge of each segment.

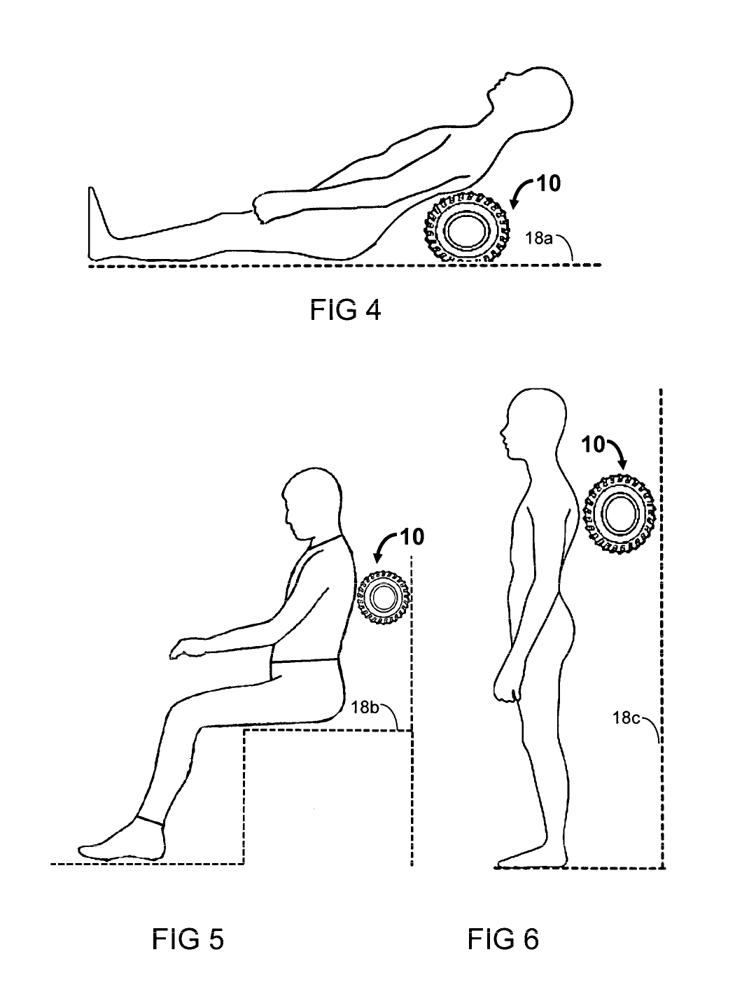

As such, the symmetric first segment 15 and second segment 17 formed on the exterior surface 27 of the roller 11 defined by the first member 12, create two curved or arched segments having two peaks which contact the user's back or body. It is preferred that the first segment 15 shape and size be a mirror configuration of the second segment 17 shape and size. This symmetry along with the recess 19 formed at a central area of the roller 11 in between curved walls of both segments, serves to maintain the device 10 in following a straight path when employed such as in FIGS. 4-6, or when used upon an arm or leg which settles into the recess 19. Non symmetrical segment sizes and circumferences would cause the roller 11 to turn when rotating which is not preferred.

The formed recess 19 is defined by a centrally located groove in the exterior surface 27 of the roller 11 formed by the first member 12. As noted, it is preferred and is adapted to form a low point between the two arched segments 15 and 17, upon the exterior surface 27 of the roller 11 to ensure that little or no pressure is communicated to the spine and nerves and nerve roots adjacent the spine of the user during use, to avoid injury, and to maintain the roller 11 working upon and arm or leg when used therewith. This recess 19, depending into the exterior surface of the roller 11 between the arched segments, also helps maintain the roller 11 with the recess centered over the spine of the user during use. The curved declining side surfaces defining the recess 19 defined by the curve of the arched first segment 15 and second segment 17, have also shown in experimentation to be preferred over a simple rectangular relief as the curved declining sides into the recess 19 worked better to keep the roller 11 centered with the recess 19 protecting the spine and adjacent nerves of the user.

As noted, the first member 12 having an exterior surface 27 and exterior circumference as described herein forms the roller 11 and can be formed of a unitary structure with no axial cavity 13. However, it has been found that forming an axial cavity 13 will lighten the formed roller 11 and render it easier to use in some instances. Further, forming the axial cavity 13 reduces the amount of material necessary to form the first member 12 defining the roller 11.

The axial cavity 13 passing through the axis of symmetry of the first member 12 forming the roller 11, when included, allows for temporary or permanent insertion and mating with the inner member 14. Insertion of an intractable or semi-rigid hollow cylindrical inner member 14, encapsulated by an elastic or malleable first member 12 defining the roller 11, provides both a substantially rigid and continuously conforming force against the user's back, for increased treatment efficacy during use.

The rigidity of the inner member 14 may be greater than the stiffness or rigidity of the first member 12 defining the roller 11. This allows a softer more pliable material forming the roller 11 but insures the roller 11 defined by the first member 12 will maintain an elongated and straight configuration during use. While not shown, the cylindrical second or inner member 14 may be capped at each end for increased distal strength. A handled roller while not shown may also be engaged using the axial passage of the inner member 14.

As noted, in a preferred mode of the device 10, the inner or second member 14 can be inserted into the axial cavity 13 and can be maintained therein by a flexible annular ledge 21 of polymeric material forming the roller 11 which overhangs the aperture communicating with the axial cavity 13 at each end of the first member 12 forming the roller 11.

In this mode the inner member 14, which currently is circular with an interior axial cavity such as a pipe or tube, has a length which is equal to or less than the length of the axial cavity 14 for the distance in-between the two ledges 21. This ledge 21 portion is sufficiently flexible and elastic to allow insertion of the inner member 14 such that when inserted through the opening centrally located within each annular ledge 21, the circular inner member 14 will be positioned within the axial cavity 13, with ledge 21 portions abutting both and preventing removal. This is especially preferred because it holds the inner member 14 secure, but allows for it to be replaced easily if bent or broken.

Alternatively, the inner member 14 and first member 12 forming the roller 11 can be permanently engaged through one or a combination of engagement from a group including shrink-fit, force fits, glue, epoxy, heat shrink or overmolding.

To accommodate the shape and geography of the human back, experimentation has shown the device 10 should have a diameter at the widest diameter of each segment 15 and 17, of between 2 and 12 inches, and a total length of 8 to 24 inches from end to end where the segments are approximately half of this length each.

Additionally, the ratio of the minimum to the maximum diameter of each arched segment 15 and 17, on the exterior of the first member 12 defining the roller 11, should be between 5 and 80 percent to ensure sufficient lateral grip against the user's back during use.

Further, the distance between the peak diameters of each arched segment 15 and 17 on the roller formed by the first member 12, should be between 30 and 90 percent of the length of the device 10 to allow for proper positioning of the recess 19 and function thereof during use.

Additionally, it is preferable that the first segment 15 and second segment 17, of the roller 11 formed by the first member 12 should contain three or more rows of three or more radially arrayed projections 16, extending from the circumferential surface. These projections 16 have been found to provide increased grip against the body of the user and the stationary surface 18 during use. Further, the projections 16 have been preferred by users as providing a finger like massage during user.

Each projection 16 should preferably be half globular or hemispherical in shape with a curved shape throughout. This is preferable to avoid points which can harm the user and be uncomfortable during use. The projections 16 can alternatively be formed as a square or round cylinder and should be sized for sufficient grip and massaging capability.

The first member 12 can be composed of one or a combination of durable flexible materials from a group including polymeric materials, foam, plastic, rubber, silicone, neoprene, polyethylene and polyurethane. The inner member 14 can be formed from one or a combination of durable rigid or semi-rigid materials such as those from a group including metal, polymeric materials, plastic, wood, PVC, polycarbonate, polystyrene, polyurethane, and polypropylene.

The protrusions 16 can be formed homogeneously with the material forming the exterior circumference of the roller 11 formed by first member 12 or from any of the alternative flexible materials listed above which may be engaged to the first member 12.

Employing the device 10 herein in one preferred mode of use herein, as seen in FIG. 4, the user lies down, places the device 10 between his or her back and a horizontal stationary surface 18a, and employs one or both legs to translate their body, and the device 10, in a horizontal direction to repeatedly treat the effected area of the back.

Alternatively, per FIGS. 5 and 6, the user can similarly place the device 10 between their back and a vertical stationary surface 18b 18c, such as a chair or wall respectively, and repeatedly translate their body and the device in a vertical direction to treat effected area of the back. It is on vertical surfaces that the protrusions 16 help to maintain the first member 12 in a rolling engagement as without them the smooth surface of the first member 12 tends to slide rather than roll.

Further, while not shown, the roller 12 may also be used to massage legs, arms, and other portions of the body of a user so the depictions of the roller 12 in use are not to be limiting. When used to massage an arm or leg, the recess 19 and downward arched sides of the recess 19 serve to maintain the roller 12 upon the arm or leg being massaged by rolling on a support surface, and also allow the projection 16 to massage the curved contours of the body of the user on the arms or legs.

As noted, any of the different configurations and components can be employed with any other configuration or component shown and described herein. Additionally, while the present invention has been described herein with reference to particular embodiments thereof and steps in the method of production, a latitude of modifications, various changes and substitutions are intended in the foregoing disclosures, it will be appreciated that in some instance some features, or configurations, or steps in formation of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

Further, the purpose of any abstract of this specification is to enable the U.S. Patent and Trademark Office, the public generally, and especially the scientists, engineers, and practitioners in the art who are not familiar with patent or legal terms or phraseology, to determine quickly from a cursory inspection the nature and essence of the technical disclosure of the application. Any such abstract is neither intended to define the invention of the application, which is measured by the claims, nor is it intended to be limiting, as to the scope of the invention in any way.

What is claimed is:

1. A massage apparatus, comprising:
a first member defining a roller, said first member having an exterior surface defining an exterior circumference extending between a first end and a second end of said roller;
said exterior circumference having a first arched segment extending from said first end to a central portion of said first member;
said exterior circumference having a second arched segment extending from said second end of said first member to said central portion thereof;
a central area of each of said first arched segment and said second arched segment defining a largest diameter of said first member;
a recess formed in said central portion of said first member in-between said first arched segment and said second arched segment; and
said recess configured to minimize contact of said exterior circumference of said first member with the central area of the back of the user with said roller in an as-used position sandwiched between the back of the user and a support surface.

2. The massage apparatus of claim 1, additionally comprising:
a plurality of projections extending away from said exterior surface of said first member, said plurality of projections extending from said exterior surface upon said first arched segment and said second arched segment.

3. The massage apparatus of claim 2, additionally comprising:
said plurality of projections positioned in rows radially extending from said exterior surface at both said first arched segment and said second arched segment.

4. The massage apparatus of claim 2, wherein said projections have a curved hemispherical shape.

5. The massage apparatus of claim 3, wherein said projections have a curved hemispherical shape.

6. The massage apparatus of claim 1 additionally comprising:
an axial cavity defined by a sidewall, said axial cavity communicating through said first member from said first end thereof to said second end thereof;
a second member positioned within said axial cavity; and
an exterior circumference of said second member positioned in contact with said sidewall of said axial cavity.

7. The massage apparatus of claim 2 additionally comprising:
an axial cavity defined by a sidewall, said axial cavity communicating through said first member from said first end thereof to said second end thereof;
a second member positioned within said axial cavity; and
an exterior circumference of said second member positioned in contact with said sidewall of said axial cavity.

8. The massage apparatus of claim 4 additionally comprising:
an axial cavity defined by a sidewall, said axial cavity communicating through said first member from said first end thereof to said second end thereof;
a second member positioned within said axial cavity; and
an exterior circumference of said second member positioned in contact with said sidewall of said axial cavity.

9. The massage apparatus of claim 6 additionally comprising:
a pair of annular ledges extending inward from said sidewall of said axial cavity, one each of said annular ledges located at each of said first end of said first member and said second end of said second member; and
said second member held in position within said axial cavity by positioning in-between said pair of annular ledges.

10. The massage apparatus of claim 7 additionally comprising:
a pair of annular ledges extending inward from said sidewall of said axial cavity, one each of said annular ledges located at each of said first end of said first member and said second end of said second member; and
said second member held in position within said axial cavity by positioning in-between said pair of annular ledges.

11. The massage apparatus of claim 8 additionally comprising:
a pair of annular ledges extending inward from said sidewall of said axial cavity, one each of said annular ledges located at each of said first end of said first member and said second end of said second member; and
said second member held in position within said axial cavity by positioning in-between said pair of annular ledges.

12. The massage apparatus of claim 1 additionally comprising:
said recess defined a first curved wall on a first side which is a portion of said first arched segment; and
said recess defined by a second curved wall on an opposite side, by a portion of said second arched segment.

13. The massage apparatus of claim 2 additionally comprising:
said recess defined a first curved wall on a first side which is a portion of said first arched segment; and
said recess defined by a second curved wall on an opposite side, by a portion of said second arched segment.

14. The massage apparatus of claim 6 additionally comprising:
said recess defined a first curved wall on a first side which is a portion of said first arched segment; and
said recess defined by a second curved wall on an opposite side, by a portion of said second arched segment.

15. The massage apparatus of claim 9 additionally comprising:
said recess defined a first curved wall on a first side which is a portion of said first arched segment; and
said recess defined by a second curved wall on an opposite side, by a portion of said second arched segment.
